(19) United States
(12) Patent Application Publication
(10) Pub. No.: US 2010/0085165 A1
(43) Pub. Date: Apr. 8, 2010

(54) RFID CHIP MEMORY UTILITY

(76) Inventors: Steve Anthony Villa, Auburn, WA (US); James O'Neil Wickline, Federal Way, WA (US)

Correspondence Address: Hayes Soloway P.C., 3450 E. Sunrise Drive, Suite 140, Tucson, AZ, 85718, US

(21) Appl. No.: 12/247,951

(22) Filed: Oct. 8, 2008

(51) Int. Cl. H04Q 5/22

(52) U.S. Cl. 340/10.51

(57) ABSTRACT

Disclosed is a computer-enabled method for writing data to the extended user memory of a Class 1 Generation 2 Radio Frequency Identification (RFID) tag. The disclosed method can also be used to format extracted maintenance data from the tag and compare it to the master database for validity.

### FIELD

The present disclosure is generally related to a system and method for managing individual part data and maintenance schedules associated with commercial equipment. The disclosure has particular utility in connection with managing individual part data and maintenance schedules associated with fleet vehicles including aircraft, and will be described in connection with such utility, although other utilities are contemplated.

### BACKGROUND

Performance of maintenance tasks associated with commercial aircraft fleets has both operational and economic impacts on the daily operations of the aircraft fleet. It is important to determine precisely optimal times or intervals for maintenance tasks to be performed to run an airline efficiently. Aircraft scheduled maintenance task intervals currently are determined using broad-brush technical data analysis techniques and “best engineering estimates.” Existing maintenance schedules are based on the use of an average time between unscheduled removals. Intervals associated with maintenance tasks are based on use of a percentage of average time between unscheduled component removals.

The foregoing background discussion derives primarily from co-pending U.S. Patent Publication No. 2008/0021604, assigned to a common assignee and incorporated by reference herein, which provides a Maintenance Interval Determination and Optimization Tool (MIDOT) for optimizing maintenance schedules for components and systems associated with a platform, such as an aircraft, based on the specific usage and the probability of survival of one or more related components. The MIDOT operates to utilize historical data from one or more components within a platform, associate a maintenance task with the one or more related components, and determine an optimal maintenance task interval to perform the associated maintenance task on the one or more related components.

For its intended use with aeronautical parts history data, MIDOT is formatted using Air Transport Association (ATA) Spec2000 Chapter 11. MIDOT currently requires that part numbers and maintenance data be manually entered into a spreadsheet for the statistical analysis to be performed. This process is aided in many instances by use of machine-readable code, such as bar codes.

Industry guidelines for traceability have been in place for many years and are contained in ATA Spec 2000 Chapter 9, Automated Identification and Data Capture (AIDC). AIDC includes standards such as bar-coding, 2d Data Matrix and RFID, which are used to mark and identify products and/or store information which can be read in an automated manner. Radio Frequency Identification (RFID) has recently been introduced for parts identification in certain applications and follows the ISO 18000-6C protocol. Benefits of using this technology include the ability to read part information without direct line of site. For example, by using RFID chips on parts of the oxygen system stored in the overhead bins, an airline would be able to check expiration without having to open the bin. Currently, the standard dictates that the “permanent part marking” data will be identical to that used on bar codes and data matrices. However, it is anticipated that a further benefit to RFID will be the ability to store additional information within the part, such as date of last removal, number of operating hours, etc.

Unfortunately, MIDOT and similar databases are not formatted for use with the RFID tags proposed in Chapter 9. Thus, an operator can recognize parts automatically using an RFID tag reader, but will still be required to manually enter maintenance data for MIDOT.

### SUMMARY

The present disclosure provides an RFID Chip Memory Utility that allows the user to read and write maintenance data for commercial fleet vehicles as it would appear on a Class 1 Generation 2 Radio Frequency tag. In this way, an airline company, for example, can implement a process of “tagging” any existing part and efficiently storing all the historical data of that part on the tag. The newly recorded RFID tag point-of-use information can be interpreted by anyone in the industry utilizing the ATA Spec2000 section 9.5 TOC container standard. The Chip Memory Utility of the present disclosure will save substantial time to the user in determining how many data records will fit on a high memory tag using current industry format.

More particularly, in one aspect of the disclosure, there is provided a computer-enabled method for managing individual part data for commercial equipment, wherein the individual part is tagged with a Radio Frequency Identification (RFID) tag, wherein the individual part data comprises a plurality of records, each record comprising a plurality of fields, the method comprising the steps of:

(a) importing the individual part data into a utility computer program;

(b) converting the imported individual part data to a delimited flat file using the utility computer program;

(c) sending the delimited flat file to an RFID read/write device; and

(d) writing the delimited flat file to the RFID tag using the RFID read/write device.

In another aspect of the disclosure, there is provided a computer-enabled method for arranging data in a storage file for writing to a Radio Frequency Identification (RFID) tag, wherein the data comprises a plurality of records, each record comprising a plurality of fields, the method comprising the steps of:

(a) checking for new records in the imported individual part data, wherein a message is sent to the user and steps (b) through (e) are omitted where there are no new records;

(b) determining if the RFID tag contains enough available user memory to write a current record to the user memory, wherein a message is sent to the user and steps (c) through (e) are omitted where there is not enough available user memory;

(c) parsing the data in the current record and writing that data to a storage file;

(d) deleting the first record from the imported individual part data; and

(e) repeating steps (b) through (d) until there are no more records or there is insufficient available user memory.

In yet another aspect of the disclosure there is provided an article of manufacture comprising information storage medium having computer readable code disposed therein and usable with a computer processor to write and process data to the user memory of a Radio Frequency Identification (RFID) tag, wherein the data comprises a plurality of records, each record comprising a plurality of fields, the method comprising the steps of:

(a) checking for new records in the imported individual part data, wherein a message is sent to the user and steps (b) through (e) are omitted where there are no new records;

(b) determining if the RFID tag contains enough available user memory to write a current record to the user memory, wherein a message is sent to the user and steps (c) through (e) are omitted where there is not enough available user memory;

(c) parsing the data in the current record and writing that data to a storage file;

(d) deleting the first record from the imported individual part data; and

(e) repeating steps (b) through (d) until there are no more records or there is insufficient available user memory.

### BRIEF DESCRIPTION OF THE DRAWINGS

The features, functions, and advantages that have been discussed can be achieved independently in various embodiments of the present disclosure or may be combined in yet other embodiments further details of which can be seen with reference to the following description and drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a flowchart showing the displaying a computer-enabled method for writing commercial fleet maintenance data to an RFID tag in accordance with the present disclosure; and

FIG. 2 is a block diagram showing the steps of a method for converting commercial fleet maintenance data for an RFID tag in accordance with the present disclosure.

### DETAILED DESCRIPTION

The present disclosure provides a Chip Memory Utility, wherein users are able to extract data from a spreadsheet, such as the MIDOT database, and write this information to an RFID tag using the current ATA Spec2000 Chapter 9.5 standard. This enables anyone to read the tag and be able to locate and interpret the data on the tag using any reader/application combination.

The Chip Memory Utility does this by creating a Table of Contents (TOC) and calculating the memory address where to store the data on a tag per the ATA standard. The Chip Memory Utility structures the TOC and MIDOT data in such a way that the file can be exported to a CSV file or any other delimited flat file. Then this file is used by a reader application to write the entire history content of a part onto an RFID tag. In this way, an airline company, for example, can implement a process of tagging any existing part and efficiently store all the historical data of that part on the tag. The newly recorded RFID tag point-of-use information can then be interpreted by anyone in the industry utilizing the ATA TOC container standard.

Use of the invention will benefit industry partners by ensuring comprehensive standards are developed with minimal impact to current processes and record keeping formats. Also, additional measures of assurance that readers function to defined standards can be obtained. The Chip Memory Utility gives the airlines the option of maintaining their current processes using ATA Spec2000 Chapter 11 or changing their process to ATA Spec2000 Chapter 9.5 for writing to RFID tags.

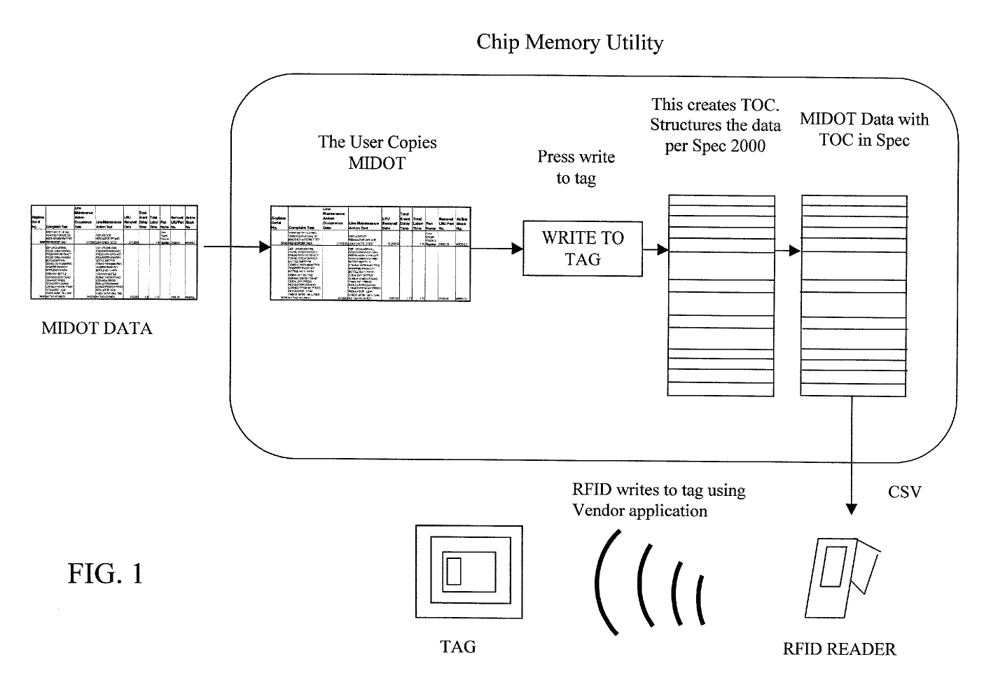

Referring to FIG. 1, the Chip Memory Utility enables a maintenance data file from MIDOT to be cut and pasted into the program on the Source Data Page (Step 1). In the example, this is done by the user. The Chip Memory Utility includes a user interface (UI) that contains buttons to read, write, and erase the user memory content of the tags and may also include configuration parameters to set the memory size and data construct such as 8 bit or 6 bit ASCII per the ATA specification.

Referring to FIG. 1, the user transforms the data by pressing the “Write to Tag” button, which initiates a program comprising a series of commands. The MIDOT data is parsed into one word (16 bits) per field or two 8 bit ASCII Characters. The result is a string text in ATA Spec2000 formatted record, such as a CSV file to be written to the RFID tag using an RFID Reader. This may be, for example, written to a separate worksheet within the utility for storage until the program completes and until the output is transferred to the RFID tag reader. A warning notice will appear when the data fields on the worksheet are full. The worksheet, in turn, is sized for the targeted RFID tag, which may be 512 bit, 8 KB, 64 KB, or any other size.

The program adds ATA Spec2000 headers and the Cycle Redundancy Check. This is the simulation of data being populated to the user memory portion in the ATA TOC container for an RFID tag. The program creates and displays Record Descriptors that displays the location of each maintenance history record. The record descriptors are loaded from top to bottom in the user memory and the maintenance records are loaded from bottom to top. When the Record Descriptors and the records meet in the middle, the user memory is full in accordance with the Air Transport Association specification. When no other records can be entered a warning message indicates that the memory is full and displays the total number of maintenance records written.

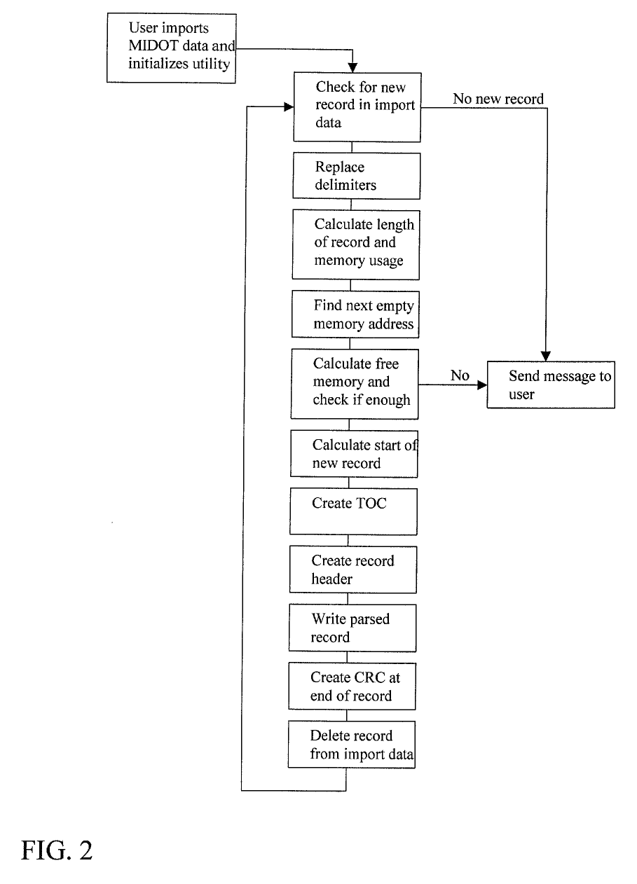

In the preferred embodiment shown in FIG. 2, the program begins by checking the imported maintenance database for new records. If no new records are found, the program sends a message to the user and the program terminates. Where at least one new record is found, the program processes the next record in sequence. The field delimiters for the next record are replaced with new delimiters, such as commas, that are compatible with the flat file format. The program then calculates the length of the record and determines the amount of memory required, finds the next available memory address and calculates the amount of free space in the user memory to determine if there is room for the new record. The available user memory in the flat file matches the available user memory on the RFID tag. If there is not enough free space in the user memory available, a message is sent to the user and the program terminates. If there is enough free memory available, the program calculates the start of the new record. The program then creates a record descriptor for the new record and appends the table of contents (TOC), and creates a corresponding record header. The data in the new record is then parsed, preferably into one word (16 bits) or two 8 bit ACSII characters, and written to the user memory. The program also creates Cyclic Redundancy Check (CRC) representation that is added to the record. The record is then deleted from the imported maintenance database and the program starts over by checking for other new records. This loop continues execution until there is not enough free space in the user memory or there are no more new records. The Chip Memory Utility also can be used to format extracted maintenance data from the tag and compare it to the master database for validity. Some Radio Frequency Identification readers allow a user to use the Active Sync software application to pull data from the reader and display it on a laptop computer. In this way the data on the tag can be compared to the data in a master database to ensure maintenance data validity.

It should be emphasized that the above-described embodiments of the RFID chip utility are merely possible examples of implementations, merely set forth for a clear understanding of the principles of the present disclosure. Many variations and modifications may be made to the above-described embodiments without departing substantially from the spirit and principles of the disclosure. For example, while the RFID chip utility is specifically described in reference to commercial aircraft fleets and MIDOT data, it is also contemplated to be used with other commercial fleets, such as buses, boats, etc. All such modifications and variations are intended to be included herein within the scope of this disclosure and protected by the following claims.

What is claimed is:

1. A computer-enabled method for managing individual part data for commercial equipment, wherein the individual part is tagged with a Radio Frequency Identification (RFID) tag, wherein the individual part data comprises a plurality of records, each record comprising a plurality of fields, the method comprising the steps of:
(a) importing the individual part data into a utility computer program;
(b) converting the imported individual part data to a delimited flat file using the utility computer program;
(c) sending the delimited flat file to an RFID read/write device; and
(d) writing the delimited flat file to the RFID tag using the RFID read/write device.

2. The method of claim 1, wherein the step of converting the imported individual part data further comprises the intermediate steps of:
(i) checking for new records in the imported individual part data, wherein the utility computer program sends a message to the user and steps (ii) through (v) are omitted where there are no new records;
(ii) determining if the RFID tag contains enough available user memory to write a current record to the user memory, wherein a message is sent to the user and steps (iii) through (v) are omitted where there is not enough available user memory;
(iii) parsing the data in the current record and writing that data to the delimited flat file;
(iv) deleting the first record from the imported individual part data; and
(v) repeating steps (ii) through (iv) until there are no more records or there is insufficient available user memory.

3. The method of claim 2, wherein intermediate step (ii) is preceded by the steps of:
searching for a first empty memory location in the delimited flat file;
determining the total available user memory; and
calculating the size of the current record.

4. The method of claim 2, wherein intermediate step (iii) is preceded by the steps of:
creating a record descriptor for the current record and appending a table of contents in the delimited flat file with the record descriptor; and
creating a record header for the current record and writing the record header to the first available memory location in the delimited flat file.

5. The method of claim 4, wherein intermediate step (iii) is followed by the step of creating a Cyclic Redundancy Check (CRC) representation for the current record that is added to the delimited flat file.

6. The method of claim 1, wherein the step of converting the imported individual part data is initiated by the user.

7. The method of claim 1, wherein the commercial equipment comprises a fleet vehicle.

8. The method of claim 7, wherein the fleet vehicle comprises an aircraft.

9. A computer-enabled method for arranging data in a storage file for writing to a Radio Frequency Identification (RFID) tag, wherein the data comprises a plurality of records, each record comprising a plurality of fields, the method comprising the steps of:
(a) checking for new records in the imported individual part data, wherein a message is sent to the user and steps (b) through (e) are omitted where there are no new records;
(b) determining if the RFID tag contains enough available user memory to write a current record to the user memory, wherein a message is sent to the user and steps (c) through (e) are omitted where there is not enough available user memory;
(c) parsing the data in the current record and writing that data to a storage file;
(d) deleting the first record from the imported individual part data; and
(e) repeating steps (b) through (d) until there are no more records or there is insufficient available user memory.

10. The article of manufacture of claim 9, wherein step (b) is preceded by the steps of:
searching for a first empty memory location in the storage file;
determining the total available user memory; and
calculating the current record size.

11. The article of manufacture of claim 9, wherein intermediate step (c) is preceded by the steps of:
creating a record descriptor for the current record and appending a table of contents in the storage file with the record descriptor; and
creating a record header for the current record and writing the record header to the first available memory location in the storage file.

12. The article of manufacture of claim 9, wherein intermediate step (c) is followed by the step of creating a Cyclic Redundancy Check (CRC) representation for the current record that is added to the delimited flat file.

13. The article of manufacture of claim 1 1, wherein the record descriptor is written to a table of contents in the top of the storage file and the record header and parsed data are written to the bottom of the available user memory in the storage file.

14. The article of manufacture of claim 9, wherein the data includes maintenance data for a part to which the RFID tag is attached.

15. An article of manufacture comprising an information storage medium having computer readable code disposed therein and useable with a computer processor to write and process data for exporting to a Radio Frequency Identification (RFID) tag, wherein the data comprises a plurality of records, each record comprising a plurality of fields, the method comprising the steps of:
(a) checking for new records in the imported individual part data, wherein a message is sent to the user and steps (b) through (e) are omitted where there are no new records;
(b) determining if the RFID tag contains enough available user memory to write a current record to the user memory, wherein a message is sent to the user and steps (c) through (e) are omitted where there is not enough available user memory;
(c) parsing the data in the current record and writing that data to a storage file;
(d) deleting the first record from the imported individual part data; and
(e) repeating steps (b) through (d) until there are no more records or there is insufficient available user memory.

16. The article of manufacture of claim 15, wherein step (b) is preceded by the steps of:
searching for a first empty memory location in the storage file;
determining the total available user memory; and
calculating the current record size.

17. The article of manufacture of claim 15, wherein intermediate step (c) is preceded by the steps of:
creating a record descriptor for the current record and appending a table of contents in the storage file with the record descriptor; and
creating a record header for the current record and writing the record header to the first available memory location in the storage file.

18. The article of manufacture of claim 15, wherein intermediate step (c) is followed by the step of creating a Cyclic Redundancy Check (CRC) representation for the current record that is added to the delimited flat file.

19. The article of manufacture of claim 17, wherein the record descriptor is written to a table of contents in the top of the storage file and the record header and parsed data are written to the bottom of the available user memory in the storage file.

20. The article of manufacture of claim 15, wherein the data includes maintenance data for a part to which the RFID tag is attached.
